(19) United States
(12) Patent Application Publication
(10) Pub. No.: US 2004/0261758 A1
(43) Pub. Date: Dec. 30, 2004

(54) Alternative-step appliance rotary piston engine

(76) Inventors: Chun Hing Fong, Hong Kong (CN); Lu De Chang, Hong Kong (CN)

Correspondence Address: JOE NIEH, 18760 E. AMAR ROAD #204, WALNUT, CA, 91789, US

(21) Appl. No.: 10/610,264

(22) Filed: Jun. 30, 2003

(51) Int. Cl. F02B 53/00

(52) U.S. Cl. 123/241

(57) ABSTRACT

The alternative-step appliance rotary engine is a rotary piston internal combustion engine. The alternative-step appliance rotary engine has twin or double twin pistons that rotate in a circular cross-section cylinder. The unique characteristic of this alternative-step appliance rotary piston engine is that it has a stop-piston that, when locked, cannot rotate until it is unlocked. Another rotary piston or a pair of rotary piston performs the four processes of the internal combustion engine: air absorption, compression, expansion, and exhaustion.

### BACKGROUND

1. Field of Invention

The present invention relates generally to a rotary piston assembly for use in a rotary piston engine. More specifically, the present invention is an alternative-step rotary piston assembly for use in a circular cross-section cylinder.

2. Description of Related Art

Rotary engines are internal combustion engines that duplicates in some fashion the intermittent cycle of the piston engine. The cycle of the piston engine consists of intake, compression, power, and exhaust cycle. The form of the power output in a rotary engine is direct mechanical rotations.

There are four general categories of rotary engines: (1) cat-and-mouse (or scissor) engines, which are analogous to reciprocating piston engine, except that the piston travel in a circular path; (2) eccentric-rotor engines, wherein the motion is imparted to a shaft by a principal rotating part, or rotor, that is eccentric to the shaft; (3) multiple-rotor engines, which are based on simple rotary motion of two or more rotors; and (4) revolving-block engines, which combine reciprocating piston and rotary motion.

The typical cat-and-mouse engine is the engine developed by T. Tschudi, the initial design which goes back to 1927. The pistons, which are sections of a torus, travel around a toroidal cylinder. The motion of the rotors, and hence the piston, is controlled by two cams which bear against rollers attached to the rotors. The cams and rollers associated with one of the rotors disengage when it is desired to stop the motion of that rotor. The shock loads associated with starting and stopping the rotors at high speeds is a problem with this engine as well as lubrication and sealing problems. Fabrication of the toroidal pistons also poses challenges.

The eccentric-rotor engine which has received by far the greatest development to date is the Wankel engine. The basic engine components comprise only two moving parts: the rotor and the eccentric shaft. The rotor moves in one direction around the trochoidal chamber, which contains peripheral intake and exhaust ports. The initial application of the Wankel engine as an automotive power plant occurred in the NSU Spider. In the early 1970s, however, the Japanese automobile manufacturer Mazda began to use Wankel engine exclusively. However, relatively high pollutant emissions, coupled with low gasoline mileage for automobiles of this size and weight, resulted in poor sales in the United States. Mazda ceased marketing Wankel-powered automobiles in the United States in the mid-1970s. Several American automobile manufacturers have experimented with Wankel-powered prototypes, but no production vehicles have emerged.

The multi-rotor engine operates on some form of simple rotary motion. A typical design operates as follows. A fuel-air mixture enters the combustion chamber through some type of valve. No compression takes place; rather a spark plug ignites the mixture which burns in the combustion chamber, with a constant increase in temperature and pressure. The hot gas expands by pushing against two trochoidal rotors. The eccentric force on the rotor forces the rotor to rotate. Eventually, the combustion gas finds their way out the exhaust. The problems with this type of engine are principally twofold: The absence of a compression phase leads to low engine efficiency, and sealing between the rotors is an enormously difficult problem. The Unsin engine, Walley and Scheffel engines, and Walter engine are multi-rotor engines.

The revolving-block engine combines reciprocating piston motion with rotational motion of the entire engine block. Stresses on the roller assembly and cylinder walls are very high, which poses some design problems. Cooling is a further problem, since cooling of the pistons is difficult to achieve in this arrangement. The Mercer engine, Selwood engine, Leath engine, Porsche engine, Rajakaruna engine, and the Ma-Ho engine are representative revolving-block engines.

Inefficiencies are inherent in the rotary engine design due to problems such as shape of the piston and the piston housing. Rotary engines has the problems of energy inefficiency due to the excessively large amount of energy consumed by the following piston and the complex construction of the piston which results in difficulties in sealing between the pistons and between the pistons and the cylinder walls. Large amount of energy loss is due to dragging of the following, or trailing, piston in the angularly forward direction during the power, or expansion, phase of the engine operation.

Furthermore, due to the inherent design of the rotary engine, the compression of the rotary engine generally cannot exceed 8 to 1 compression ratio, even with a turbo charger such as the design described in U.S. Pat. No. 5,415,141. Other designs, such as the one disclosed in the China patent no. 96231991.0, that use springs to motivate the pistons also has problems due to the heating the spring which relaxes the elasticity of the spring. Another design that utilizes various joints within the cylinder, such as the one disclosed in China patent number 95227114.1, have difficulties in sealing. Yet another design compressed the air in a separate compartment from the ignition compartment such as the one disclosed in China patent numbers 93239534.1 and 95242836.9 has its own separate set of problems. The present invention avoids the above problems with a very simple design containing only two pairs of gears to control the entire cycle.

As can be concluded, engines of the eccentric-rotor type are an integral part of the internal combustion engine scene. Their inherent simplicity, coupled with their advanced state of development, make them attractive alternatives to the piston engine in a number of applications. However, although there are various rotary engine designs, as described above, each design has its limitations and inefficiencies. Therefore there is no successful current production or commercialized rotary engine in the market.

### SUMMARY OF THE INVENTION

The present invention is an alternative-step appliance rotary piston internal combustion engine. The alternative-step appliance rotary engine has twin or double twin pistons that rotate in a circular cross-section cylinder. The unique characteristic of this alternative-step appliance rotary piston engine is that it has a stop-piston that, when locked, cannot rotate until it is unlocked. Another rotary piston or a pair of rotary piston performs the four processes of the internal combustion engine: air absorption, compression, expansion, and exhaustion.

### BRIEF DESCRIPTION OF THE DRAWINGS

FIG. 1 shows the main assembly of the alternative-step appliance rotary engine.

FIGS. 2-1, 2-2, 3-1, 3-2, 4-1, and 4-2 show the gears of the alternative-step appliance rotary engine at various rotational angles.

FIGS. 5-1 and 5-2 show the single beetle piston of the alternative-step appliance rotary engine.

FIG. 6 shows the cross-sectional view of the cylinder block of the alternative-step appliance rotary engine.

FIG. 7 shows the cross-sectional view of the cylinder block with a pair of single-beetle piston in the cylinder block of the alternative-step appliance rotary engine.

FIGS. 8-1 and 8-2 show the gears of the “half cycle” alternative-step appliance rotary engine.

FIG. 9 shows the assembly of the “half-cycle” alternative-step appliance rotary engine

FIGS. 10-1 and 10-2 show the double beetle piston of the alternative-step appliance rotary engine.

FIG. 11 shows the cross-sectional view of the cylinder block with a double-beetle piston in the cylinder block of the alternative-step appliance rotary engine.

FIG. 12 shows the cross-sectional view of the cylinder block of the alternative-step appliance rotary engine.

FIG. 13 shows the cross-sectional view of the cylinder block with a double-beetle piston in the cylinder block of the alternative-step appliance rotary engine.

FIGS. 14-1 and 14-2 show the two pairs of gears of the “half cycle” alternative-step appliance rotary engine.

FIGS. 15-a and 15-b show the two pairs of pistons and gears of the alternative-step appliance rotary engine in various rotational angles.

FIG. 16 shows the assembly of the twin-double piston of the “half cycle” alternative-step appliance rotary engine.

FIGS. 17-1, 17-2, 18-1, and 18-2 show the various shapes of double-beetle piston of the alternative-step appliance rotary engine.

FIGS. 19-1, 19-2, 20, 21-1, 21-2, and 22 show the gears and pistons of the alternative-step appliance rotary engine formed in one unit.

FIGS. 23-1, 23-2, and 23-3 show top, bottom, and bottom view of the assembly of components in FIGS. 21-1, 21-2, and 22 of the of the alternative-step appliance rotary engine.

FIG. 24 shows the cross-section of the assembly of FIG. 23-2 of the alternative-step appliance rotary engine.

FIG. 25 shows a half-round gear engaged to the gear of FIG. 23-2 to control the movement of the piston of the alternative-step appliance rotary engine.

### DETAILED DESCRIPTION OF THE PREFERRED EMBODIMENT

The alternative-step appliance rotary piston engine is an internal combustion engine. The alternative-step appliance rotary piston engine uses two coaxial half rounded gears to engage two other gears with lock head to alternately rotate and pause during the cycle.

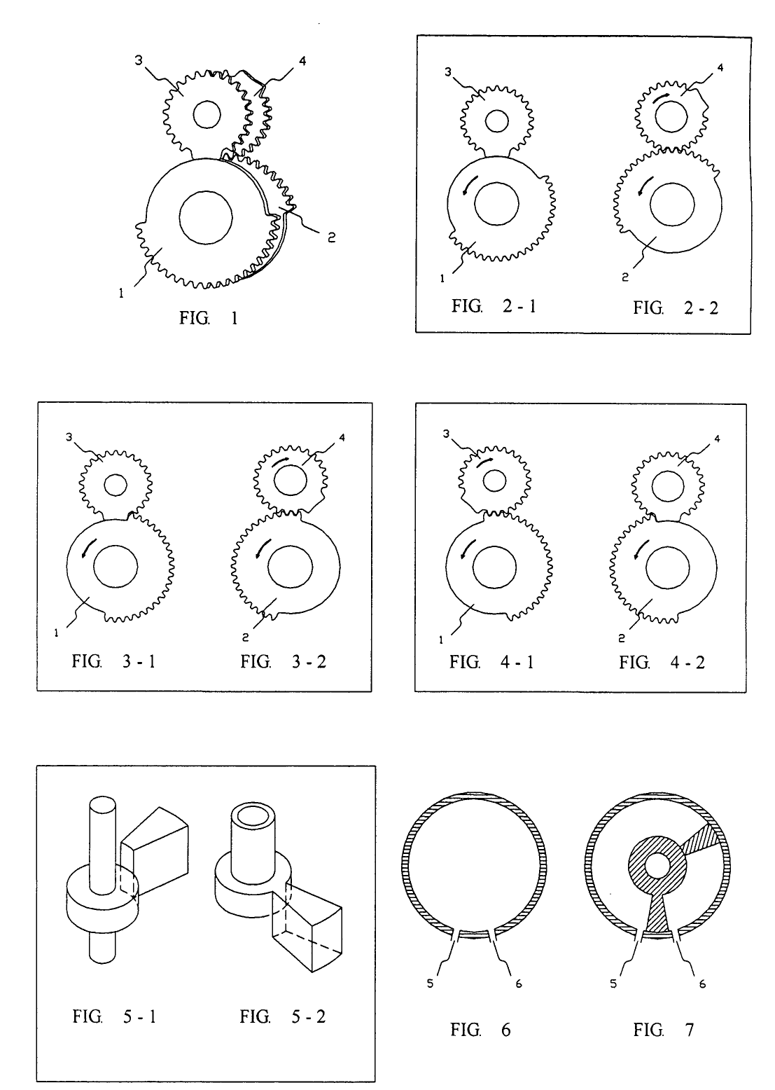

FIG. 1 is the main assembly of the alternative-step appliance rotary engine. A first half rounded gear 1 and a second half rounded gear 2 are coaxial mounted and are rotatable as a unit and are generally about the same diameter. The gears on the first half rounded gear 1 are positioned 180 degrees from the gears on the second half rounded gear 2. For a first half rounded gear 1 and a second half rounded gear 2 with 2n number of teeth, the semicircle arc may be formed by removing n number of teeth to form the half rounded gears.

A first gear with lock head 3 and a second gear with lock head 4 are coaxially mounted and are independently rotatable and engages the first half rounded gear 1 and the second half rounded gear 2 respectively. The edge of the lock heads on the gears with lock head 3, 4 are in the form of an arc that conforms with the smooth curvatures of the half rounded gears 1, 2. For a first gear with lock head 3 and a second gear with lock head 4 with n+m+l number of teeth, the lock head may be formed with a width of m number of teeth, including the teeth tips of the two sides of the teeth. The preferred central angle of the lock head should not be less than 40 degrees. This means that the central angle of the m+l teeth should be greater than or equal to 40 degrees.

FIG. 2-1 shows the engagement of the first half rounded gear 1 to the first gear with lock head 3. FIG. 2-2 shows the engagement of the second half rounded gear 2 to the second gear with lock head 4. When the first half rounded gear 1 and the second half rounded gear 2 rotates counterclockwise the first gear with lock head 3 will not rotate due to the engagement of the lock head to the smooth curvatures on the first half rounded gear 1. The second gear with lock head 4 will rotate in synchronized angular velocity with the rotation of the second half rounded gear 2 due to the engagement of the gears on the second gear with lock head 4 and the gears on the second half rounded gear 2.

As the counterclockwise rotation of the first half rounded gear 1 and the second half rounded gear 2 continues, the lock head on the first gear with lock head 3 will reach the end of the smooth curvature on the first half rounded gear 1 as shown in FIG. 3-1 and the lock head on the second gear with lock head 4 with begin to engage the smooth curvatures on the second half rounded gear 2 as shown in FIG. 3-2. Further rotation of the first half rounded gear 1 and the second half rounded gear 2 will result in the engagement of the gears on the first gear with lock head 3 to engage the gears on the first half rounded gear 1 and begin to rotate as shown in FIG. 4-1 while the lock head on the second gear with the lock head 4 will engage the smooth curvatures on the second half rounded gear 2 and be prevented from further rotation as shown in FIG. 4-2.

It is clear that one complete rotation of the first half rounded gear 1 and second half rounded gear 2 will also result in one complete rotation of the first gear with lock head 3 and the second gear with lock head 4. This will be referred to as a “one cycle alternative-step appliance rotary piston engine.”

When a first single-beetle piston as shown in FIG. 5-1 is affixed to the first gear with lock head 3 and a second single-beetle piston as shown in FIG. 5-2 is affixed to the second gear with lock head 4 and the entire assembly is then assembled into a cylinder block shown in FIG. 6, the basic structure is formed for a pump machine, a compressor, or an engine as shown in FIG. 7. The cylinder block shown in FIG. 6 has an air intake hole 5 and an air exhaust hole 6 to allow entry and exit of the air into and out of the cylinder block. When the first single-beetle piston is in the position between the air intake hole 5 and the air exhaust hole 6 separating the two holes as shown in FIG. 7, the first single-beetle piston is in the locked position wherein the lock head on the first gear with lock head 3 is engaged to the smoothed curvature on the first half rounded gear 1. The function of the second single-beetle piston is to enclose and expel the air in the cylinder block thereby resulting in the operation of the structure as a pump or a compressor.

The structure may operate as an internal combustion engine when a flywheel is axially attached to the same shaft as the first half rounded gear 1 and the second half rounded gear 2. When the air pressure from the internal combustion pushes against the second single-beetle piston, the second single beetle piston will rotate clockwise and in turn the first single-beetle piston will also rotate clockwise thereby rotating the first half rounded gear 1 and the second half rounded gear 2 counter clockwise. The rotation of the first half rounded gear 1 and the second half rounded gear 2 will transmit their rotation energy to the flywheel through their common shaft.

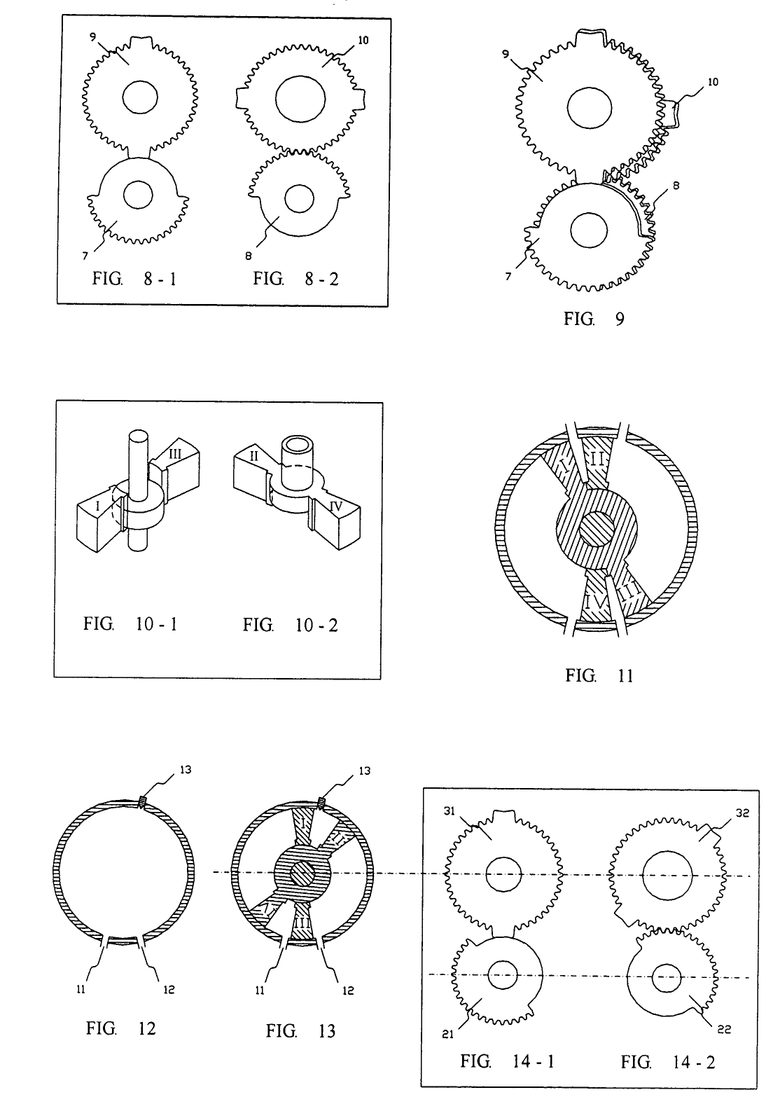

FIG. 8-1 shows a first gear with two lock heads 9 engaged to a first half rounded gear 7. FIG. 8-2 shows a second gear with two lock heads 10 engaged to a second half rounded gear 8. For a first gear with two lock heads 9 and a second gear with two lock heads 10 with 2(n+m+l) number of teeth, divided into two groups with n+m+l number of teeth in each group, each lock head may be formed with a width of m number of teeth, including the teeth tips of the two sides of the teeth. The preferred central angle of the lock head should not be less than 30 degrees. This means that the central angle of the m+l teeth should be greater than or equal to 30 degrees.

FIG. 9 shows the alternative assembly of the alternative-step appliance rotary engine. It is clear that in this structure, one rotation of the half rounded gears 7, 8 will only rotate the gears with two lock heads 9, 10 one-half rotation. This will be referred to as the “half cycle alternative-step appliance rotary piston engine.”

When a first twin-beetle piston as shown in FIG. 10-1 is affixed to the first gear with two lock heads 9 and a second twin-beetle piston as shown in FIG. 10-2 is affixed to the second gear with two lock head 10 and the entire assembly is then assembled into a double-twin spiracle cylinder block shown in FIG. 11, the basic structure is formed for an twin-entry and twin-exhaust pump machine, compressor, or external combustion engine, such as the Stirling engine.

When a first twin-beetle piston as shown in FIG. 10-1 is affixed to the first gear with two lock heads 9 and a second twin-beetle piston as shown in FIG. 10-2 is affixed to the second gear with two lock head 10 and the entire assembly is then assembled into a cylinder block shown in FIG. 12, the basic structure is formed for an internal combustion engine as shown in FIG. 13. An intake hole 11 and an exhaust hole 12 is defined by the cylinder block with a spark plug or a fuel nozzle 13 extending into the cylinder block. The chamber enclosed by the cylinder block is divided into four compartments by the first twin-beetle piston and the second twin-beetle piston as shown in FIG. 13.

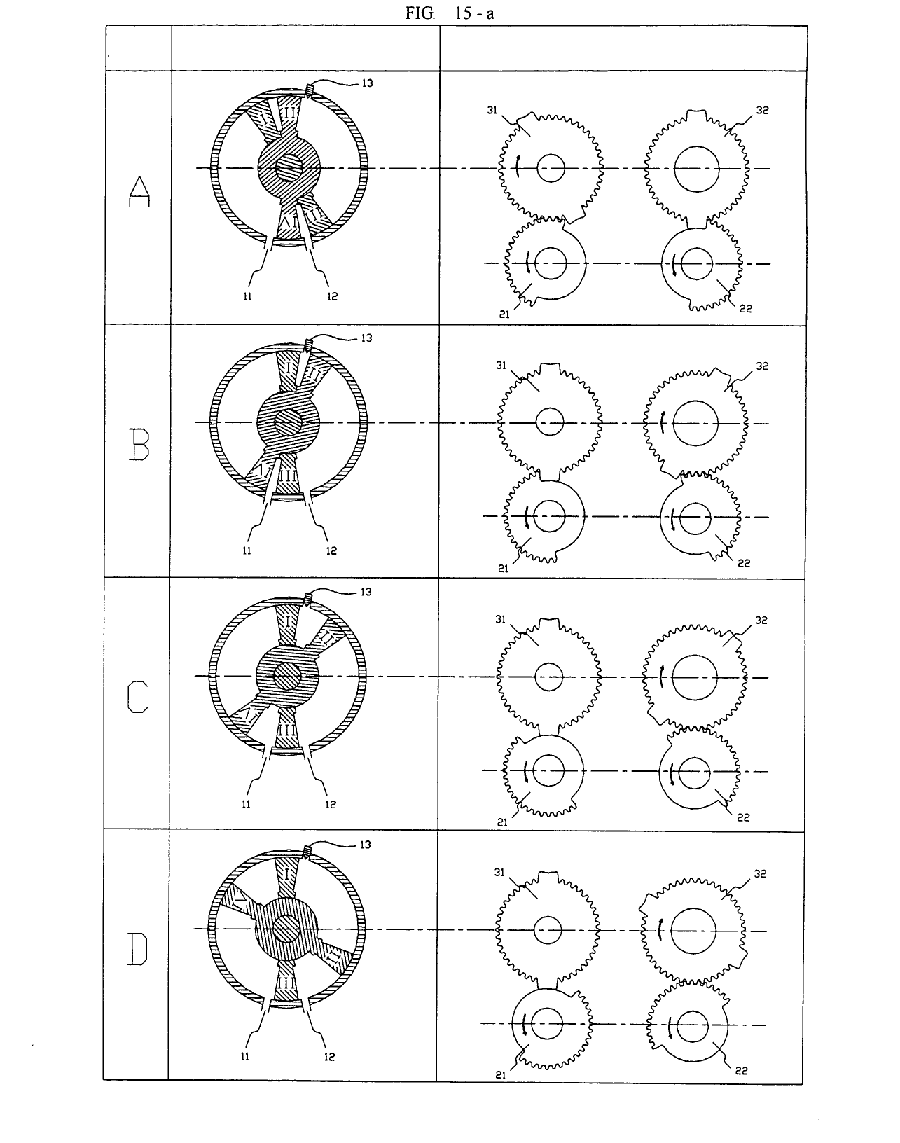

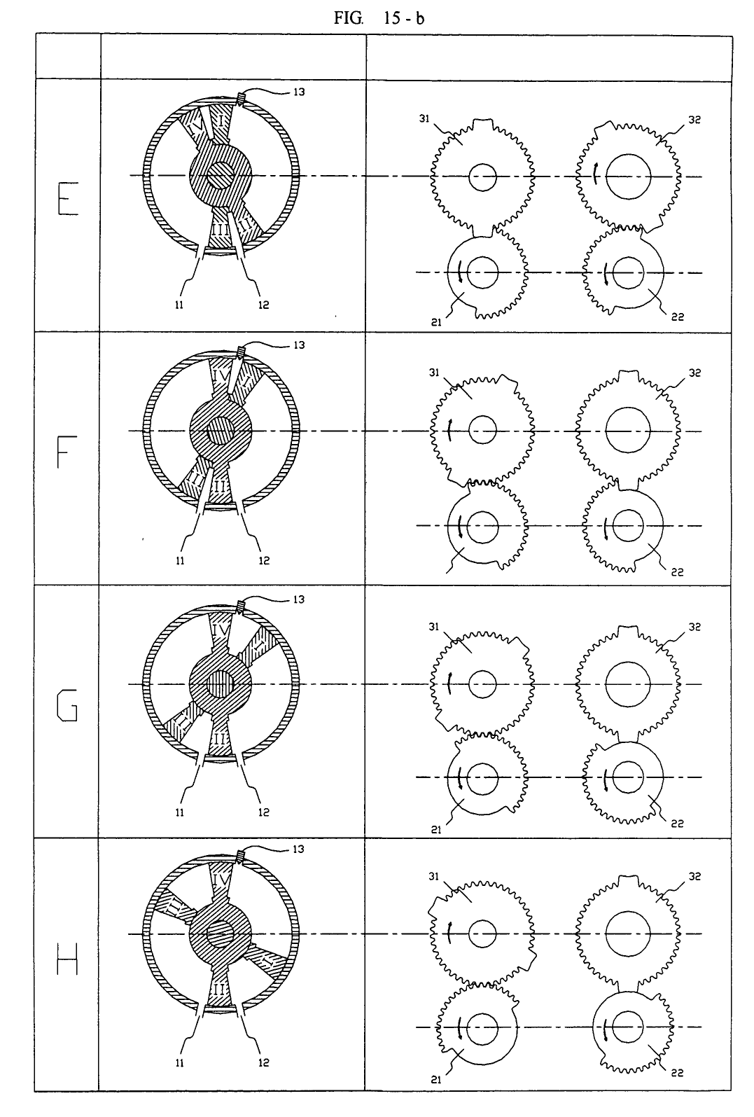

FIGS. 14-1 shows the position of the first half rounded gear 21 and the first gear with two lock heads 31 wherein the first twin-beetle piston is affixed to the same shaft as the first gear with two lock heads 31. FIGS. 14-2 shows the position of the second half rounded gear 22 and the second gear with two lock heads 32 wherein the second twin-beetle piston is affixed to the same shaft as the second gear with two lock heads 32. A unidirectional flap may be installed on the pivots of the first gear with two lock heads 31 and the second gear with two lock heads 32 to reduce the stress on the lock heads. The first half rounded gear 21 and the second half rounded gear 22 are affixed to the same shaft and outputs the power produced to a flywheel affixed to the same shaft.

FIGS. 15-a and 15-b shows the operation of the structure at different stages identified as A through H. Assume that the first half rounded gear 21 and the second half rounded gear 22 are rotating counterclockwise in FIGS. 15-a and 15-b. At stage A the gaseous mixture in the I-II compartment is compressed completely. The lock head of the first gear with two lock heads 31 is locked and the second gear with two lock heads 32 is released and rotating. The first half rounded gear 21 and the second half rounded gear 22 will rotate clockwise continuously due to the inertia from the flywheel.

At stage B the lock head of the first gear with two lock heads 31 engages the smooth curvatures on the first half rounded gear 21 and locks in its current position. The spark plug 13 ignites the compressed gas in the I-II compartment. Since the first twin-beetle piston and the first gear with two lock heads 31 are locked in their position, the compressed gas will force the second twin-beetle piston and the second gear with two lock heads 32 to rotate clockwise. The second twin-beetle piston and the second gear with two lock heads 32 will rotate through stages C, D, and eventually reaches stage E. During this process, the compress gas in the I-II compartment will expand and the gas in the II-III compartment is being discharged. At the same time, the III-IV compartment is being filled with gaseous mixture while the gas mixture in I-IV compartment is being compressed.

At stage E the compressed gas in the I-II compartment has been decompressed and the gas in the II-III compartment has been discharged. The III-IV compartment has been filled with the gaseous mixture and the gaseous mixture in the I-IV compartment has compressed. At this time, it is in a similar state as in stage A.

Continuing with the operation, stage F is similar to stage B. Stage G is similar to stage C. Stage H is similar to stage D. Therefore, at stage H, the operation had two ignitions while the shaft attached to the first half rounded gear 21 and the second half rounded gear 22 rotated one complete rotation.

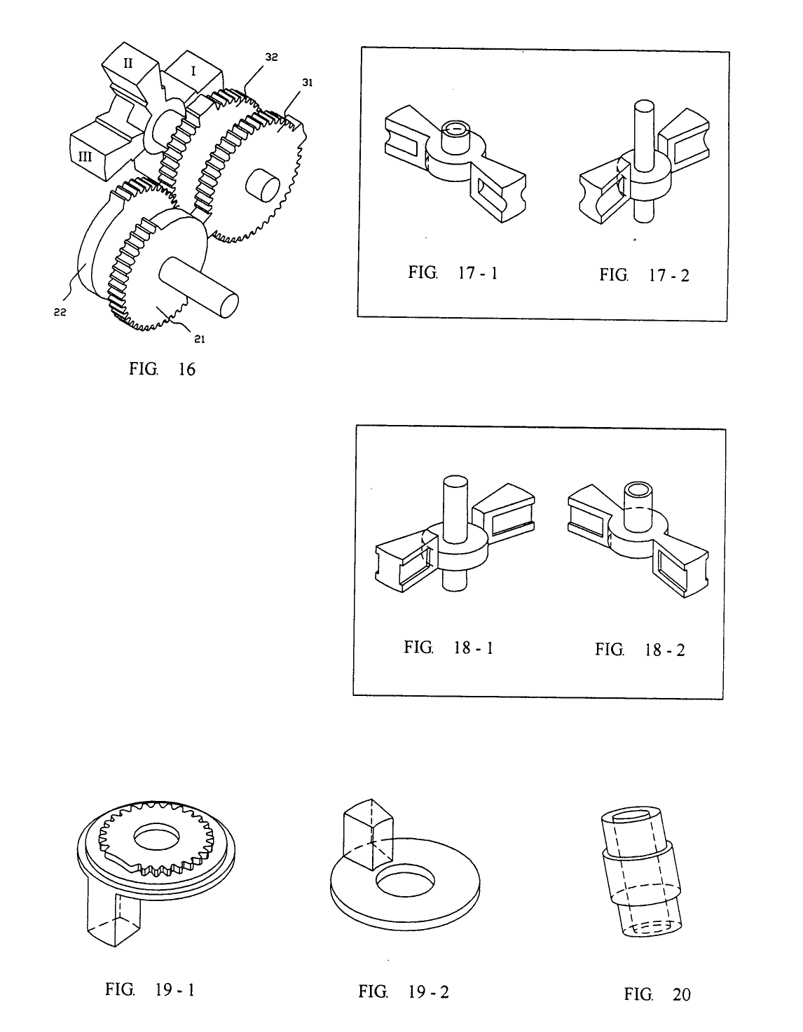

FIG. 16 is an perspective view of the “half cycle alternative-step appliance rotary piston engine.”

Since the compression ratio is dependent on the volume of space between the first twin-beetle piston and the second twin-beetle piston various designs of the twin-beetle piston may be utilized to obtain the desired compression ratio. FIGS. 10-1, 10-2, 17-1, 17-2, 18-1, and 18-2 are some possible designs of the twin-beetle piston. The twin-beetle piston designs in FIGS. 10-1 and 10-2 have a solid face. The twin-beetle piston design in FIGS. 17-1 and 17-2 have a rounded concave face while the twin-beetle piston design in FIGS. 18-1 and 18-2 have a rectangular concave face.

The pistons and the gear with lock head may be assembled on one side or both sides of the cylinder block. If the piston and its coaxial gear with lock head are formed as one unit, a single-beetle piston can be manufactured as shown in FIGS. 19-1 and 19-2, which are the bottom and the top perspective views of the unit, and can be assembled on one side of the cylinder block. If the piston and its coaxial gear are formed as one unit and mounted face to face on an axel shown in FIG. 20 and assembled in the cylinder block, the pistons and the gear with lock head will be assembled on both sides of the cylinder block.

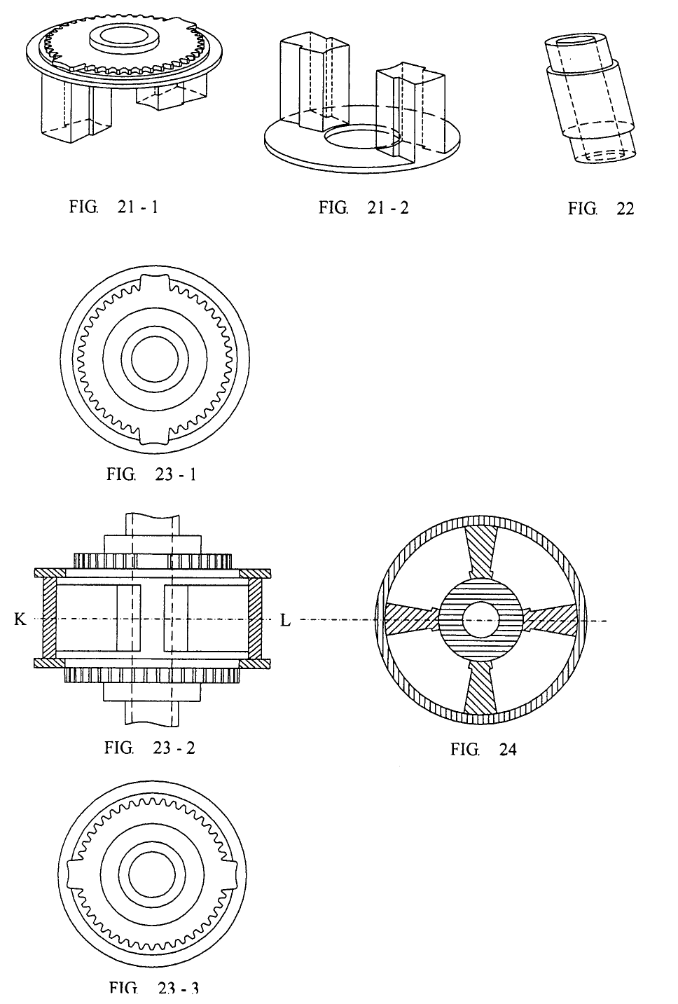

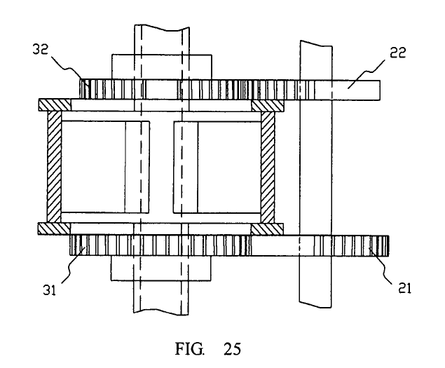

A twin-beetle piston and its coaxial gear with lock head can be manufactured as one unit as shown in FIGS. 21-1 and 21-2, which are the bottom and the top perspective views of the unit. If the twin-beetle piston and its coaxial gear are formed as one unit and mounted face to face on a axel shown in FIG. 22 and assembled in the cylinder block, the twin-beetle pistons and the gear with lock head will be assembled on both sides of the cylinder block as shown in FIG. 23-2. FIG. 23-1 is the top view of the FIG. 23-2 assembly. FIG. 23-3 is the bottom view of the FIG. 23-2 assembly. FIG. 24 is the cross-sectional view of the FIG. 23-2 assembly. FIG. 25 shows the cross-sectional view of the FIG. 23-2 assembly with the first half rounded gear 21 and the second half rounded gear 22 engaged to the corresponding gear with lock head.

The advantages of forming the piston and the gear with lock head as one unit is that the number of components is reduced and the machining only takes place on one component. Furthermore, the tolerances can be decreased and efficiency of the manufacturing operation can be increased.

The above design may incorporate two or more sparkplugs installed on the cylinder block. The above design may also incorporate valves in the air-intake hole to regulate the amount of gas inputted.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. An alternative-step appliance rotary piston engine comprising:
a first half rounded gear;
a second half rounded gear coaxially mounted with the first half rounded gear and are rotatable as a unit;
a first gear with a lock head that terminates in an arc in the same profile as the first half rounded gear positioned to allow engagement of its gears with the first half rounded gear;
a second gear with a lock head that terminates in an arc in the same profile as the second half rounded gear coaxially mounted with the first gear with a lock head and are independently rotatable and positioned to allow engagement of its gears with the second half rounded gear;
a first single-beetle piston coaxially affixed to the first gear with a lock head; and
a second single-beetle piston coaxially affixed to the second gear with a lock head;
wherein the entire assembly is assembled into and rotates within a circular cylinder block and can operate as a pump machine, a compressor, or an engine.

2. An alternative-step appliance rotary piston engine according to claim 1, wherein the gears on the first half rounded gear are positioned approximately 180 degrees from the gears on the second half rounded gear.

3. An alternative-step appliance rotary piston engine according to claim 1, wherein the circular cylinder block has an air intake hole and an air exhaust hole to allow entry and exit of the air into and out of the circular cylinder block.

4. An alternative-step appliance rotary piston engine according to claim 2, wherein the circular cylinder block has an air intake hole and an air exhaust hole to allow entry and exit of the air into and out of the circular cylinder block.

5. An alternative-step appliance rotary piston engine according to claim 1, wherein the first single-beetle piston and the first gear with a lock head are formed as one unit and wherein the second single-beetle piston and the second gear with a lock head are formed as one unit.

6. An alternative-step appliance rotary piston engine according to claim 2, wherein the first single-beetle piston and the first gear with a lock head are formed as one unit and wherein the second single-beetle piston and the second gear with a lock head are formed as one unit.

7. An alternative-step appliance rotary piston engine according to claim 1, wherein the circular cylinder block has one or more spark plugs.

8. An alternative-step appliance rotary piston engine according to claim 3, wherein the circular cylinder block has a valve positioned at the air intake hole to regulate the amount of gas inputted into the circular cylinder block.

9. An alternative-step appliance rotary piston engine according to claim 4, wherein the circular cylinder block has a valve positioned at the air intake hole to regulate the amount of gas inputted into the circular cylinder block.

10. An alternative-step appliance rotary piston engine comprising:
a first half rounded gear;
a second half rounded gear coaxially mounted with the first half rounded gear and are rotatable as a unit;
a first gear with two lock heads that each terminates in an arc in the same profile as the first half rounded gear positioned to allow engagement of its gears with the first half rounded gear;
a second gear with two lock heads that terminates in an arc in the same profile as the second half rounded gear coaxially mounted with the first gear with two lock heads and are independently rotatable and positioned to allow engagement of its gears with the second half rounded gear;
a first twin-beetle piston coaxially affixed to the first gear with two lock heads; and
a second twin-beetle piston coaxially affixed to the second gear with two lock heads;
wherein the entire assembly is assembled into and rotates within a circular cylinder block and can operate as a pump machine, a compressor, or an engine.

11. An alternative-step appliance rotary piston engine according to claim 10, wherein the gears on the first half rounded gear are positioned approximately 180 degrees from the gears on the second half rounded gear.

12. An alternative-step appliance rotary piston engine according to claim 10, wherein the circular cylinder block has an air intake hole and an air exhaust hole to allow entry and exit of the air into and out of the circular cylinder block.

13. An alternative-step appliance rotary piston engine according to claim 11, wherein the circular cylinder block has an air intake hole and an air exhaust hole to allow entry and exit of the air into and out of the circular cylinder block.

14. An alternative-step appliance rotary piston engine according to claim 10, wherein the first single-beetle piston and the first gear with a lock head are formed as one unit and wherein the second single-beetle piston and the second gear with a lock head are formed as one unit.

15. An alternative-step appliance rotary piston engine according to claim 11, wherein the first single-beetle piston and the first gear with a lock head are formed as one unit and wherein the second single-beetle piston and the second gear with a lock head are formed as one unit.

16. An alternative-step appliance rotary piston engine according to claim 10, wherein the circular cylinder block has one or more spark plugs.

17. An alternative-step appliance rotary piston engine according to claim 12, wherein the circular cylinder block has a valve positioned at the air intake hole to regulate the amount of gas inputted into the circular cylinder block.

18. An alternative-step appliance rotary piston engine according to claim 13, wherein the circular cylinder block has a valve positioned at the air intake hole to regulate the amount of gas inputted into the circular cylinder block.
